(19) United States
(12) Patent Application Publication
(10) Pub. No.: US 2007/0168118 A1
(43) Pub. Date: Jul. 19, 2007

(54) System for coordinating the routes of navigation devices

(76) Inventors: Dirk Lappe, Karlsruhe (DE); Stefan Wolf, Schwieberdingen (DE); Hermann Dibos, Remchingen (DE); Guido Hovestadt, Wickede-Ruhr (DE)

Correspondence Address: BRINKS HOFER GILSON & LIONE, P.O. BOX 10395, CHICAGO, IL, 60610, US

(21) Appl. No.: 11/495,168

(22) Filed: Jul. 28, 2006

Related U.S. Application Data
(63) Continuation-in-part of application No. 10/562,083.

(30) Foreign Application Priority Data
Jun. 27, 2003 (EP) 03 014 761.5

(51) Int. Cl. G01C 21/00

(52) U.S. Cl. 701/207; 701/200

(57) ABSTRACT

Navigational systems direct and coordinate routes through an information exchange. Through processes that monitor position and communicate with mobile ground-based systems, the navigational systems provide users with accurate information about their position and velocity. Locations may be confirmed or derived by computing differences between the time that a signal is sent and the time it is received.

### PRIORITY CLAIM

This application is a Continuation-in-Part application based on U.S. application Ser. No. 10/562,083, filed Dec. 23, 2005, and claims the benefit of priority from International Application No. PCT/EP2004/006858, filed Jun. 24, 2004, and European Application No. 03014761.5, filed Jun. 27, 2003, all of which are entirely incorporated by reference herein.

### BACKGROUND OF THE INVENTION

1. Technical Field

The disclosure relates to navigation devices. In particular, the disclosure relates to navigation devices that coordinate navigation information with other navigation devices.

2. Background

Global positioning systems (GPS) may be used in vehicles. The navigation systems may calculate the current position of a vehicle using signals. These signals may include positional and timing data, used to determine a vehicle's current position. Some GPS systems may include an interface that receives position or other identification data.

Some navigation systems may communicate with other devices. The navigation system may communicate by a mobile phone. Although some systems may share information, these devices do not coordinate routes. Therefore, a need exists for a navigation device that coordinates routes through other navigation devices.

### SUMMARY

A navigation device communicates with other devices to coordinate routes. The navigation devices may process position, speed, and traffic or other information monitored or processed by other devices. Some navigation devices include a GPS receiver that receives positional data, an external data receiver that receives information from external devices, a user interface operative to receive commands, and a central processor that calculates routes. The devices may include a transmitter that communicates with a network.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a navigation system.

FIG. 2 is an alternate navigation system.

FIG. 3 is a process that determines a route.

FIG. 4 is a process that coordinates a first and second navigation device.

FIG. 5 is a process that determines a rendezvous position with an external device.

FIG. 6 is an alternate navigation system.

FIG. 7 is a vehicle bus in communication with various devices.

FIG. 8 is an alternate vehicle bus.

FIG. 9 is a vehicle information and entertainment system.

FIG. 10 is an alternate vehicle information and entertainment system.

### DETAILED DESCRIPTION OF THE PREFERRED EMBODIMENTS

A system coordinates navigation devices to increase the safety or operating efficiency of vehicles. Two or more navigation devices may communicate directly with each other, or through an intermediary device, such as a host. The navigation systems may coordinate intermediate positions to recalculate routes based on information received from external devices.

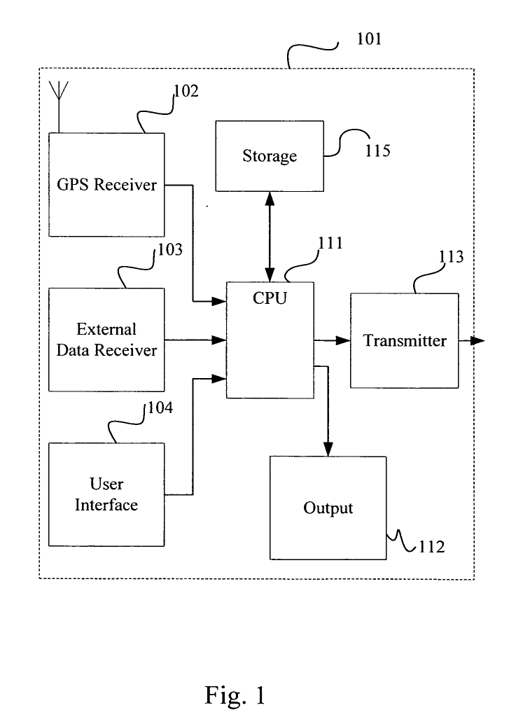

FIG. 1 illustrates a navigation system, such as a first navigation device 101. The first navigation device 101 may include a first receiver, such as a global positioning system (GPS) receiver 102 that may be configured to receive and decode signals from satellites providing positional and time relevant data relating to the position of the satellites. The first navigation device 101 may include a user interface 104 that may allow a user to communicate with the first navigation device 101. The interface may receive input route coordinates or destinations. The user interface 104 may provide functionality for activities desired by the user. Some user interfaces include speech recognition units, haptic interfaces, touch screens and touch pads, capacitance detection pads, keypads, keyboards, wireless fobs, wireless interfaces, and wireless or wired remotes interfaced to the first navigation device 101. In one system, the user interface 104 includes a speech recognition system that may control some or all of the operation of the first navigation device 101, including route coordination. The user interface 104 may receive commands that control the route coordination process so that a reliable voice control may be achieved. The user interface 104 may include a device that facilitates manual control of the route coordination process, and may include a joystick, touch pad, track ball, or dial.

The first navigation device 101 may include a calculating unit, such as a central processing unit (CPU) 111. The CPU 111 may include a dedicated microprocessor, a microcontroller, a field programmable gate array (FPGA), an application specific integrated circuit (ASIC), a custom integrated circuit, an integrated circuit, or a discrete semiconductor device. The CPU 111 may also include software, programmed algorithms, firmware, routine, object code, or other logic. The software and hardware may control the navigation and/or entertainment and/or comfort of a vehicle, in which the first navigation device 101 may be installed. The CPU 111 may determine positional data from the data received by the first and second receivers 102 and 103, respectively. In some systems, the CPU 111 controls the user interface 104 and an output device 112. The output device 112 may include audible and visual devices. The audible devices may include stereo loudspeakers, both interfaced and separate from the output device 112, headphones, such as supra-aural, over-the-ear, and in-the-ear headphones, noise-canceling headphones, Bluetooth headsets, and communications headsets. The visual devices may include liquid crystal display screens (LCD), cathode ray tube screens (CRT), organic lighted electronic diode displays (OLED), LED displays, plasma displays, digital light projection (DLP) displays, thin film transistor displays (TFT), and other screen displays.

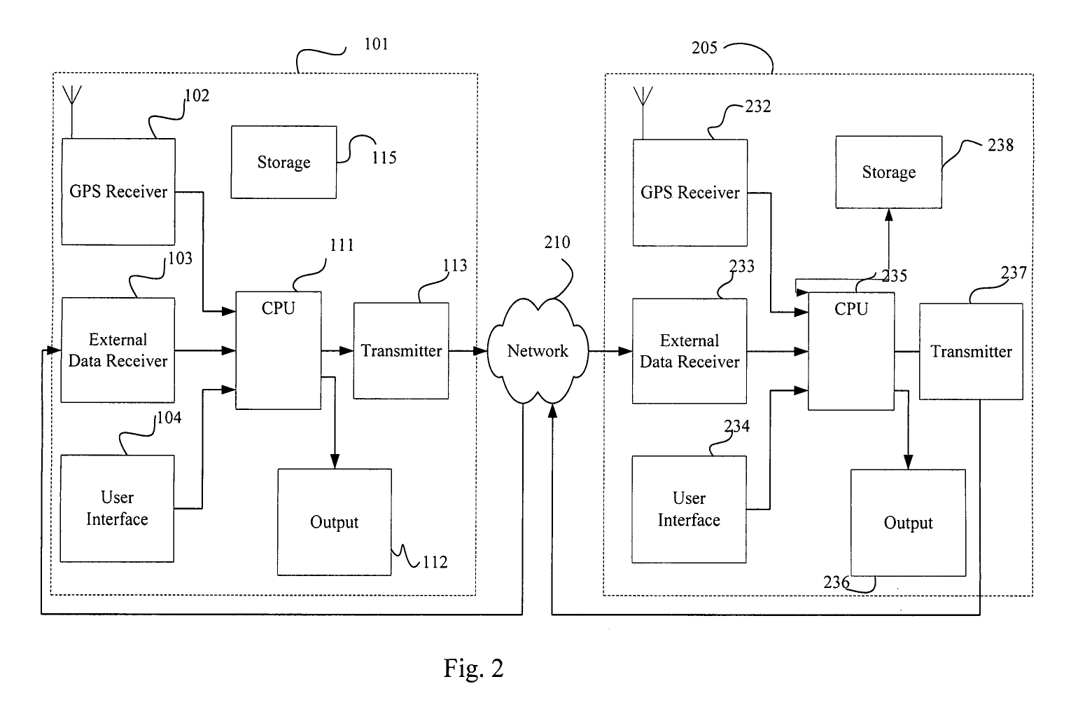

FIG. 2 illustrates an alternate navigation system with a first navigation device 101, a second navigation device 205 and a network 210. The second navigation device 205 may have a similar or different configuration from the first navigation device 101. In some systems, the second navigation device 205 includes a first receiver, such as a GPS receiver 232, a second receiver, such as an external data receiver 233, a user interface 234, a calculating unit, such as CPU 235, an output device 236, and a transmitting module, such as a transmitter 237. In one system, an RF transmitter in the transmission module 113 directly communicates with the second navigation device 205. In other systems, the transmitter 113 includes a transmitter such as a wireless device or phone that communicates through networks. The networks may support Global System for Mobile Communications (GSM), Advanced Mobile Phone Service (AMPS), Code Division Multiple Access (CDMA), Time Division Multiple Access (TDMA), Frequency Division Multiple Access (FDMA), General Packet Radio Service (GPRS), cellular digital packet data (CDPD), or other network protocols.

A transmission module, such as a transmitter 113 and 237 may be in communication with the CPU 111 and 235 and may provide data to the network 210. The transmitter 113 and 237 may include a wireless and/or a wired interface to communicate with the network 210. The wireless interfaces may include analog or digital radio, infrared, microwave, or television transmissions, WiFi, WiMax, Bluetooth, cellular, or Bluetooth interfaces. The wired interfaces may include coaxial, BNA, RCA, twisted copper, FireWire, serial, parallel, and USB wired connections.

The network 210 may comprise a network that facilitates wireless data communication, such as optical data transmission, analog or digital radio, infrared, microwave, or other electromagnetic transmission, cellular, WiFi, WiMax, or Bluetooth transmissions. The network 210 may comprise hardware that expedites data communication, and may include routers, modems, transmitters, amplifiers, multiplexers, power sources, buffers, power protection, transmission media, and cabling. In some systems, the network may include a landline or other media that enable a direct or intermediate connection between navigation devices. In other systems, the network 210 may support other protocols or other links. Other protocols may include GSM, AMPS, CDMA, TDMA, FDMA, GPRS, or CDPD.

The first navigation device 101 may include a second receiver, such as an external data receiver 103 that may receive and decode data through the network 210. The external data receiver 103 may include an interface. The interface may comprise a wireless interface that may enable data exchange through one or more communications standards. The interface may include electromagnetic transmissions such as analog or digital radio, infrared, microwave, or television transmissions, WiFi, WiMax, Bluetooth, cellular, or Bluetooth interfaces. The interface may include an infrared interface to receive data from an external or separate device, such as a mobile phone, a portable computer, a Personal Digital Assistant (PDA), a portable electronic device, or a navigation device. In some systems, the interface may include a wired connection to the network 210. The interface may include wired connections include coaxial, BNA, RCA, twisted copper, FireWire, serial, parallel, and USB wired connections. In one system, the external data receiver 103 includes a radio frequency (RF) stage that receives and decodes signals transmitted from the second navigation device 205.

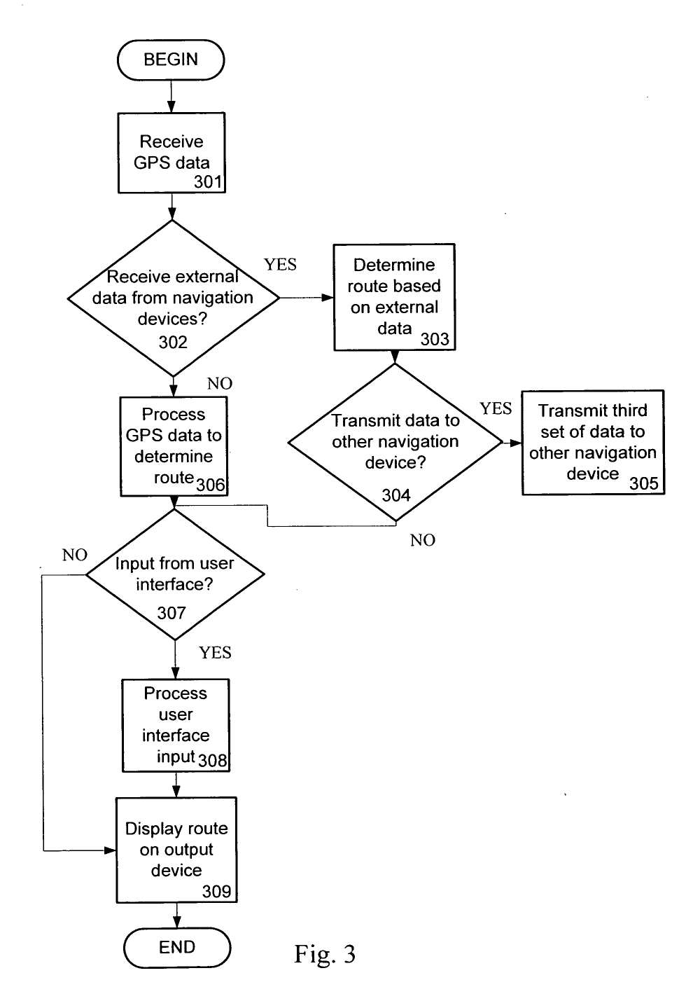

FIG. 3 illustrates a process that may coordinate navigation devices. A first navigation device 101 may receive a first set of data, such as positional data, that is received and processed by the first receiver, such as the GPS receiver 102, at block 301. The first navigation device 101 may determine if a second set of data has been received from an external device through the external data receiver 103, at block 302. The second set of data may include positional information of other navigation devices, traffic information, road conditions, road closure information, weather, emergency alerts, points of interest, or other geographic or cartographic information. The external devices may include a second navigation device 205, network servers, information service providers, desktop personal computers, laptop and notebook computers, PDA's, cellular phones, network appliances, network computers, and other electronic devices that may communicate with the first navigation device 101.

When a second set of data is received, the first navigation device 101 may determine a route based on the second set of data, at block 303. The first navigation device 101 may then decide whether to transmit a third set of data from the first navigation device 101 to an external device, such as a second navigation device 205, at block 304. The third set of data may include a portion of the first set of data, such as positional data from the first navigation device 101. If the first navigation device 101 determines that the third set of data is to be transmitted, the first navigation device will transmit the third set of data through the transmitter 113. The transmitter 113 may include a wireless and/or a wired interface to communicate with network 210. The wireless interfaces may include analog or digital radio, infrared, microwave, or television transmissions, WiFi, WiMax, Bluetooth, cellular, or Bluetooth interfaces. The wired interface may include coaxial, BNA, RCA, twisted copper, FireWire, serial, parallel, and USB wired connections. In one system, a RF transmitter in the transmitter 113 directly communicates with the second navigation device 205. In other systems, the transmitter 113 includes a transmitter such as a mobile phone so that data communication may be performed through the networks of one or more providers of mobile phone services. The mobile phone service standards may include GSM, AMPS, CDMA, TDMA, FDMA, or CDPD. If the first navigation device determines that the third set of data is not to be transmitted, the first navigation device 101 may determine if there is user input received through the user interface 104, at block 307. Further processing may be performed using user input. The first navigation device 101 may resolve conflicts between user input received through the user interface 104 and route information determined externally of the first navigation device 101.

When a second set of data is not received through the external data receiver 103, at block 302, the first navigation device 101 may process the first set of data to determine a route based on the first set of data, such as positional data provided by the GPS receiver 102, at block 306. The first navigation device 101 may also use information accessed from a storage 115. The storage 115 may be interfaced with the first navigation device 101, or may be a unitary part of the first navigation device 101. The storage 115 may include non-volatile memory such as dynamic random access memory (DRAM), static random access memory (SRAM), volatile memory such as flash memory, erasable programmable read only memory (EPROMs), electrically erasable programmable read only memory (EEPROMs), removable media such as Zip drives, Syquest drives, removable hard disk units, solid state memory such as hard disk drives, holographic memory, and magnetic random access memory (MRAM) devices, and disc media such as compact discs (CDs), digital versatile discs (DVDs), mini-discs, other memory devices and/or some combination thereof.

The storage 115 may retain data related to geographic information, such as roads, intersections, grid points, traffic direction and signal information, building information, phone numbers, addresses, points of interest, terrain and cartographic information, and other geographic information. The first navigation device 101 may access stored information related to previous routes calculated by the first navigation device 101, prior user selections and preferences, and other parameters associated with route selection and determination.

When the first navigation device 101 determines that no external data is received from other devices, at block 302, the first navigation device 101 may process navigation data, such as GPS data, to determine a route, at block 306. The first navigation device 101 may use information such as vehicle location, speed, altitude, bearing, determined preference information, and other route information to determine the route. The first navigation device 101 may determine if user input has been provided through the user interface 104, at block 307. If the first navigation device 101 determines that there is user input, the first navigation device 101 may process the user interface input, at block 308. If there is no user interface input, the first navigation device 101 may send the determined route on the output device 112, at block 309. The user interface 104 may process a spoken word and may include a speech recognition module. The user interface 104 may include a touch input module such as a touch pad, track ball, track pointer, pen stylus, joystick, keyboard, or touch sensitive screen, an optical input such as a laser pointer or light pen, or a wired or wireless remote to transmit commands or input to the user interface 104. The process illustrated in FIG. 3 may also be performed with the second navigation device 205 as the initiating device, with the components of the second navigation device 205 performing similar functions as the components of the first navigation device 101.

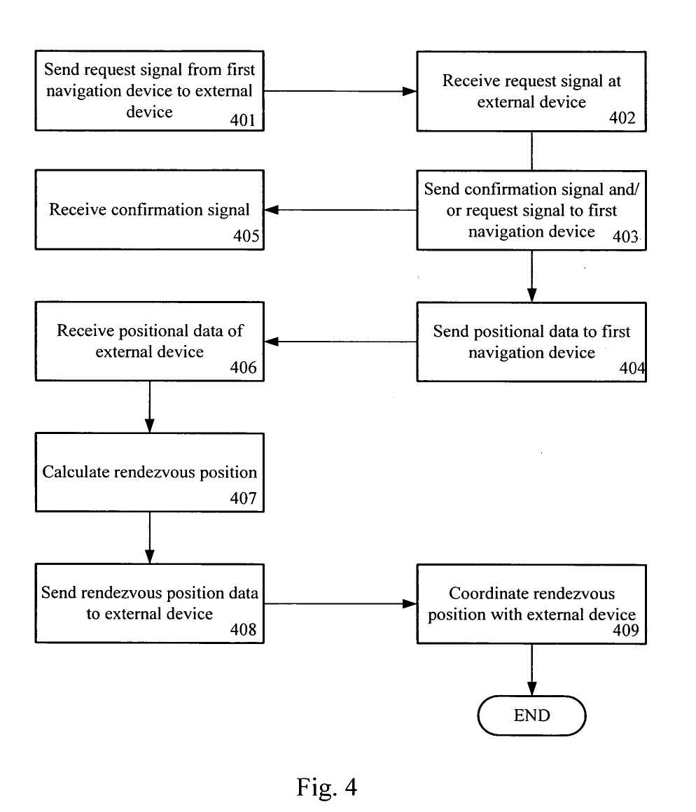

FIG. 4 illustrates a route coordination process for the first and second navigation devices 101 and 205. The first navigation device 101 may transmit, through the transmitter 113, a first request signal through the network 210, at block 401. The first request signal may include an identification of the calling first navigation device 101, a specification of the type of route coordination requested, status information, messages, or other information. The transmitter 113 may send, through the user interface 104, a request for determining a common rendezvous position of the first and second navigation devices 101 and 205. The common rendezvous position may include a desired place of meeting or other position where the users of the first and second navigation devices 205 may desire a common destination.

The second navigation device 205 may receive the first request signal at the external data receiver 233, at block 402. The first request signal may be decoded and forwarded to the second CPU 235. A rendezvous request may be reported to the user by the output device 236, as instructed by the second CPU 235.

The second navigation device 205 may send a confirmation signal, at block 403. The confirmation signal may be sent upon user request received through the user interface 104. The confirmation signal may include an identification of the second navigation device 205. An identification process may assure that the route coordination is performed for the specified first and second navigation devices 101 and 205 and minimize unauthorized access. The second navigation device 205 may also transmit a second request signal to the first navigation device 101. The second request signal may include data requests for positional information, velocity, estimated arrival time of the first navigation device 101 to the rendezvous or other locations, current traffic, road, construction, or weather conditions near the first navigation device 101, or other information. The second request signal may be received by the first navigation device 101 through the external data receiver 103.

Information, such as information contained in the confirmation signal or the second request signal may be transmitted simultaneously or after a delay or serially or in parallel by the second navigation device 205, at block 404. The information may contain the current position of the second navigation device 205. The information provided by the second navigation device 205 may include data related to the average speed, relative speed, position, bearing, or altitude of the second navigation device 205.

The confirmation signal may be received and decoded by the external data receiver 103, at block 405. The confirmation signal for route coordination may be indicated to user by the output device 112. The confirmation signal may be displayed on a display screen, played through loudspeakers, or presented to a user by other media. The positional information, which may include the current position of the second navigation device 205, may be received and decoded by the first navigation device 101 and supplied to the CPU 111, at block 406. The information may be sent simultaneously or serially to the CPU 111. Locations may be confirmed or derived by computing differences between the time that a signal is sent and the time it is received.

The CPU 111 may determine whether to modify the route of the first navigation device 101 and of the second navigation device 205, at block 407. The CPU 111 may use the information contained in the received data. The CPU 111 may determine a rendezvous position related to the GPS data received by the GPS receiver 102, the position data received from the second navigation device 205, or other criteria and parameters. Such criteria may include selecting the rendezvous position. A rendezvous position may be based on distances separated or traveled by vehicles, or may be chosen so that both vehicles arrive at a rendezvous position at the about the same time. Other criteria and parameters may also be used. The selection of these criteria and parameters may be programmed or set at the user's discretion. The rendezvous position may be reported to the user of the first navigation device 101 through the output device 112 to allow the user to reject the proposed rendezvous position and initiate a route recalculation based on different criteria and parameters. The user may also select a route recalculation using data stored in the storage 115. The user may select from previously calculated routes, user favorites, selected points of interest or selected routes, or other criteria or data stored in the storage 115.

The positional data may be sent through the transmitter 113 to the second navigation device 205, at block 408. Other information may be sent, such as vehicle identification, trip odometer information, points of interests, status information, or other messages. The data transmitted by the first navigation device 101 may be received and decoded by the second navigation device 205 and supplied to the CPU 235 through the external data receiver 233, at block 409, where a rendezvous position with an external device is coordinated.

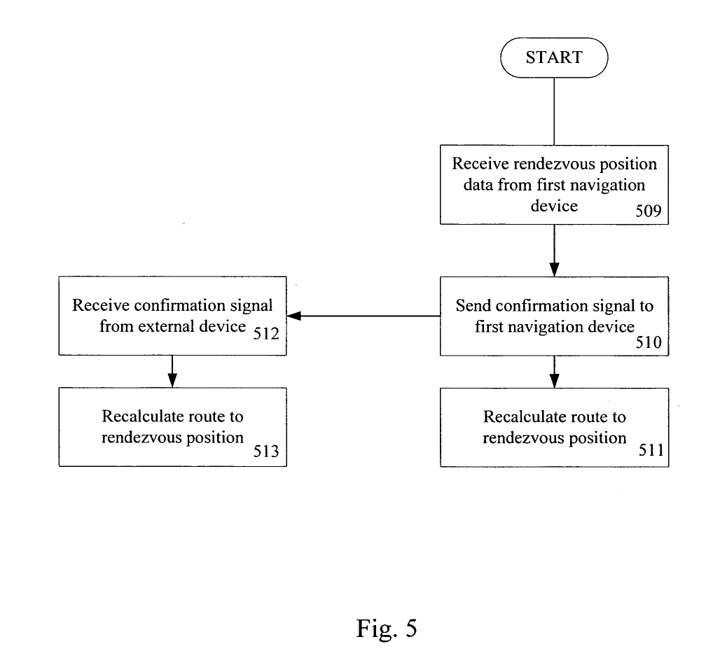

FIG. 5 illustrates a process that coordinate a rendezvous position with an external device. The data transmitted by the first navigation device 101 may be received and decoded by the second navigation device 205 and sent to the CPU 235 by the external data receiver 233, at block 509. The CPU 235 may provide the proposed rendezvous position to the user through the output device 236. The user may then confirm or reject the proposed rendezvous position through the user interface 234. A confirmation signal may be transmitted in response to the proposed rendezvous position, at block 510.

The second navigation device 205 may recalculate the route, at block 511, after accepting the proposed rendezvous position. The recalculation may be based on the GPS data received by the GPS receiver 232 and the proposed rendezvous position. The proposed rendezvous position may serve as a destination point for the recalculated route of the second navigation device 205. When the second navigation device 205 needs more information from the first navigation device 101 to determine whether to accept or reject the proposed rendezvous position, the second navigation device 205 may repeat acts at block 403. The second navigation device 205 may send a request signal to the first navigation device 101, indicating that the second navigation device 205 needs further information related to the proposed rendezvous position. The process may continue with block 404.

The first navigation device 101 may receive the confirmation signal, at block 512. The confirmation signal may be decoded and analyzed by the first navigation device 101. The CPU 111 may process the confirmation signal. The CPU 111 may recalculate the route of the first navigation device 101, at block 513, based on the GPS data and/or the rendezvous position.

The navigation system 200 may update the positional data delivered by the second navigation device 205 when the user accepts the route coordination. The update may occur automatically without user interaction. The rendezvous position may be changed according to parameters related to the route, user position, user selections, or other parameters. In other systems, the first and second navigation devices 101 and 205 may notify users when a rendezvous position may not be suggested or reached. In some systems, the user may be informed when the rendezvous position may not be reached without ignoring predetermined criteria or parameters that were set by a user. For example, if a road, intersection, or intermediate point along the route to the rendezvous position is closed or inaccessible, the user may be informed and prompted to select a different route.

The navigation devices 101 and 205 may be symmetrical with respect to their route coordination function, where either navigation device 101 or 205 may function as a counterpart to the other navigation device. In some systems, the CPU 111 may be part of a master-slave architecture, where one of the CPU's, such as CPU 111 may be configured as a master device. The transmission of the first or second request signal may configure the navigation device as the master device. The route coordination function may be applied to more than two navigation devices.

The method illustrated in FIG. 5 may calculate positional data and determine a route for the user of the first navigation device 101 based on its own current position and based on the current position of a second navigation device 205. The method may provide the user with an increased degree of flexibility in planning a route, and provide a search or rendezvous function for route planning. The first positional data may provide a route having a common rendezvous point with a route derived from the second navigation device 205. The calculation of positional data based on internal position data and positional data received by an external navigation device may be used in ground vehicles, boats, vehicles capable of flight and devices used for hiking and other outdoor activities. The method of FIG. 5 may be implemented in vehicles with limited operator distraction.

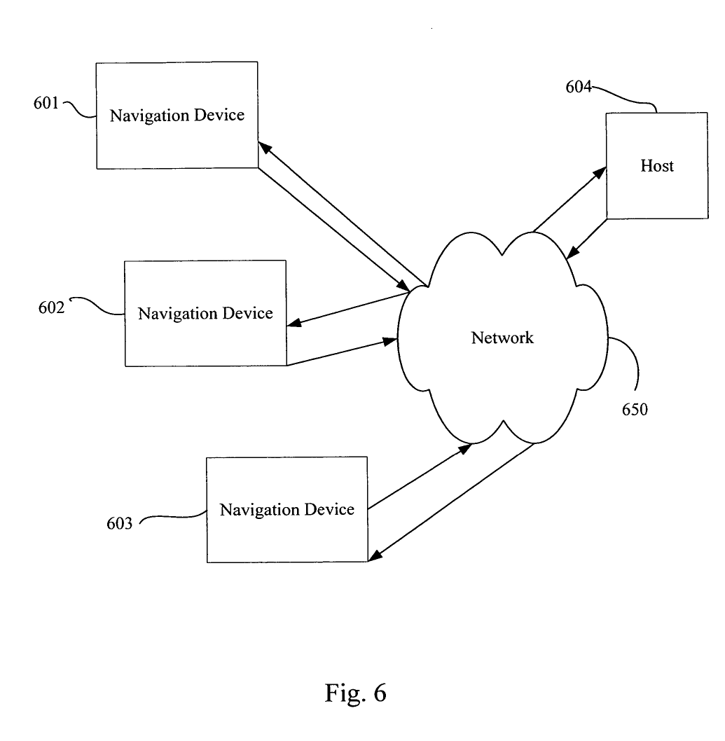

FIG. 6 illustrates an alternate navigation system 600 that has navigation devices 601, 602, and 603, a communication network 650, and a host 604. The navigation devices 601, 602, and 603 may have similar or different configurations than those described in FIG. 1 or FIG. 2. The navigation devices may communicate across a network 650. The network 650 may include a wireless data medium that uses an optical data protocol, an analog or a digital protocol, an infrared protocol, a microwave protocol, or other electromagnetic transmission protocols, wireless protocols, WiFi protocols, WiMax protocols, or Bluetooth protocols. The network 650 may include routers, modems, transmitters, amplifiers, multiplexers, power sources, buffers, power protection, transmission media, and cabling. In some systems, the network may include communication links that enable a direct or intermediate connection between the navigation devices 601, 602, and 603. In other systems, the network 650 may support mobile phone communication protocols such as GSM, AMPS, CDMA, TDMA, FDMA, GPRS, CDPD, or other network protocols.

In some systems, the host 604 may include a master device. In other systems, the host 604 may include a computer system that coordinates the plurality of navigation devices 601, 602, and 603. The host 604 may be connected to a content provider or to a service provider that supplies relevant data and services to the host unit 604. A host may include a computer, mobile computers, PDA's, servers, network computers, network appliances, wireless telephones, and other electronic devices.

During operation the navigation devices 601, 602, and 603 may transmit a request for route coordination. The request may be transmitted under predefined conditions, such as a request for a rendezvous point for the navigation devices 601, 602, and 603. The host 604 may determine the routes based on the configuration of the navigation devices 601, 602, and 603 and may determine the rendezvous point. In some systems, the navigation devices 601, 602, and 603 determine the routes based upon receipt of the rendezvous point. The host 604 may check the routes of the navigation devices 601, 602, and 603 and may update the routes based on additional information, such as information regarding traffic congestion density, construction and road condition information, weather, alerts, presence of parking lots or other driver amenities and information. In some systems, the host 604 determines rendezvous points based on previous routes, points of interest, selected favorite locations, or other predetermined information. In some systems, the host 604 may evaluate the quality of previous rendezvous points and generate a hierarchy of rendezvous points for selection. The system may learn to determine rendezvous points based on user selections or user programming. The system may also coordinate routes without the use of a host 604.

In other systems, the navigation devices 601, 602, and 603 may request intermediate destinations to allow the navigation devices to recalculate a corresponding route based on the intermediate destinations and GPS data. The navigation devices 601, 602, and 603 may determine a route of minimum journey time. The minimum journey time routes may be used when traffic flow is impeded. Other criteria may be selected in alternate systems. The criteria may be based on minimum travel distance, use of or avoidance of freeways or certain classes of roads, bridges, ferries, or tunnels, and other criteria. The host 604 may calculate intermediate destinations for the navigation devices 601, 602, and 603 and may communicate the data to the navigation devices 601, 602, and 603. If the host 604 is informed about the destinations, the current position, the average speed, and the total number of navigation devices, the host 604 may determine intermediate destinations to meet specified requirements, such as avoiding traffic jams, avoiding predetermined locations, roads, bridges, ferries, tunnels, or other positions.

If the navigation devices 601, 602, and 603 are configured to operate in a large number of vehicles, the vehicles may be equipped with the navigation devices and the vehicle routes may be coordinated without a host 604. GPS may allow the navigation systems to operate independently from the host 604 when data communication is interrupted or is not efficient. The resolution of the intermediate destinations supplied by the host 604 may be selected relatively coarsely because the fine-scale routing may use GPS data. The resolution or level of discreteness with which the intermediate destinations are supplied may be adjusted based on the availability of host or other network resources.

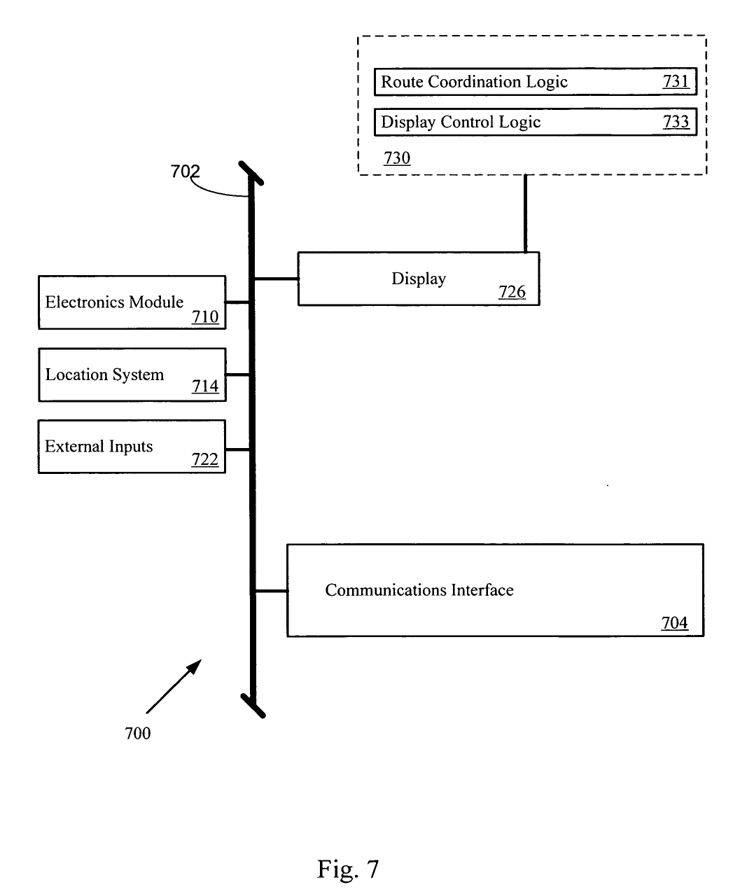

FIG. 7 illustrates a vehicle bus system 700 with components interfaced to the bus 702. The vehicle bus system 700 may be coupled with a vehicle information and entertainment system. The vehicle system bus 700 may include vehicle electronics modules 710 and a location system 714 interfaced to the system bus 702. The vehicle system bus 700 may include external inputs 722 coupled with to the system bus 702. External inputs 722 may include video, audio, synchronization, data communication, or other signal inputs. The vehicle system bus 700 may include a communications interface 704 to allow the vehicle system components interfaced to the vehicle system bus 702 to communicate with each other. The vehicle system bus 700 may include a display 726. The display 726 may be interfaced to a display processor 730. The display processor 730 may include route coordination logic 731 and display control logic 733. Examples of system bus architecture include Local Interconnect Network (LIN), Controller Area Network (CAN), J1939, ISO 1783, FlexRay, Media Oriented Systems Transport (MOST), Keyword Protocol 2000 (KWP2000), Vehicle Area Network (VAN), DC-BUS, IDB-1 394, and SMARTwireX.

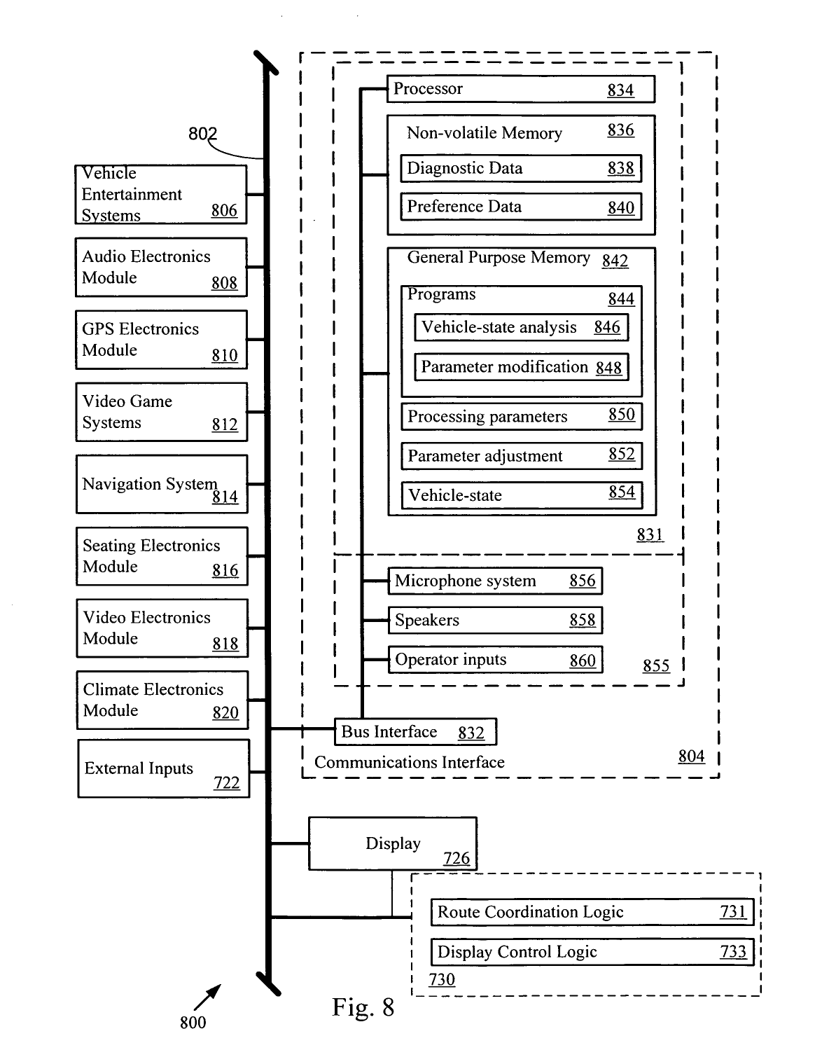

FIG. 8 illustrates an alternate vehicle bus system 800. The vehicle bus system 800 may include additional modules coupled to a system bus 802. Vehicle control modules may include a vehicle entertainment system 806, an audio electronics module 808, a GPS electronics module 810, video game systems 812, a navigation system 814, a seating electronics module 816, a video electronics module 818, and a climate and/or comfort electronics module 820. The vehicle system bus 800 may include a communications interface 804 to allow the vehicle system components interfaced to the bus 802 to communicate with each other.

The vehicle modules 806-820 and 722 may send video signals to the display 726, and may access the display 726 through the bus 802. For example, the vehicle entertainment systems 806 may include a DVD player, CD player, video cassette player, portable music players, portable electronic devices, or mobile computers which may use the display 726 for displaying video signals. The navigation system 814 may send map data such as directional, location, or point of interest data to the display 814. The video game systems 812 may transmit a video signal to the display 726. Any of the vehicle electronics modules, such as the audio electronics module 808, the GPS electronics module 810, the seating electronics module 816, the entertainment and comfort module, or the climate and/or comfort electronics module 820 may transmit a video and/or audio signal to the display 726.

The communications interface 804 may include a processing module 831, an input/output module 855, and a bus interface 832. The processing module 831 may include a processor 834, a non-volatile memory module 836, and a general purpose memory module 842. The processor 834 may include one, two, or more processors dedicated to different tasks within the vehicle bus system 800, or the processors may share the processing load of the system 800. The processor 834 may include special purpose processors such as graphics, video, DSP, or sound processors. The processor may comprise a microprocessor, a microcontroller, a DSP, an ASIC, an FPGA, or other integrated circuit device.

The non-volatile memory module 836 may include a diagnostic data module 838 and a preference data module 840. The diagnostic data module 838 and the preference data module 840 may comprise partitions of the non-volatile memory module 836, or may comprise separate modules interfaced with the non-volatile memory module 836. The diagnostic data module 838 may store data associated with the operation of the vehicle, such as engine data, tire pressure, fluid levels and pressures, battery charge level, temperature, tachometer data, and other vehicle performance information. The preference data module 840 may store information associated with driver and/or passenger settings and preferences such as seat and/or mirror configurations, climate control preferences, radio station settings, and other preference information. The non-volatile memory module 836 may be a flash memory, a floppy disk, hard disk drive, removable media such as DVD or CD, or other solid state memory device that retains data for a substantial period of time.

A general purpose memory module 842 may include a programs module 844, a processing parameters module 850, a parameter adjustment module 852, and a vehicle state module 854. The programs module 844 may include a vehicle-state analysis module 846 and a parameter modification module 848. Any of the modules 844-854 may be partitions of the general purpose memory module 842 or may be separate modules interfaced with the general purpose memory module 842. The programs module 844 may retain programs that coordinate routes. The programs module 844 may comprise software, firmware, or logic operative to execute the acts described in FIGS. 3-5.

The programs module 844 may also include data associated with operations of the communications interface 804 or data associated with operations of other modules interfaced with the bus 802. The programs module 844 may include firmware, source code, or object code stored in the general purpose memory 842, or within the vehicle-state analysis module 846 or the parameter modification module 848. The vehicle-state analysis module 846 may include data associated with the vehicle's status and diagnostic information. The vehicle-state analysis module 846 may include instructions and/or logic for responding to certain vehicle states, alerting the occupant of the vehicle to certain vehicle states, or transmitting signals to other modules interfaced to the bus 802 within the vehicle. The parameter modification module 848 may include instructions and/or logic for modifying parameters associated with the vehicle operation or vehicle state, such as engine parameters, electronics parameters, navigation parameters, communications parameters, or other vehicle operation parameters.

The processing parameters module 850 may include data, instructions, and/or code for storing, processing, or responding to processing parameters associated with the operations of the communications interface 804. The processing parameters module 850 may store settings related to the input/output module 855 or the bus interface 832. The processing parameters module 850 may retain data related to navigation route preferences, preferred rendezvous positions, preferred routes or landmarks, or other route information. The parameter adjustment module 852 may include data, instructions, and/or code for adjusting parameters associated with the communications interface 804 or input/output module 855, such as microphone, speaker, keyboard, joystick, touch pad, or remote settings, or settings for other input units interfaced to the communications interface 804. The vehicle-state module 854 may store data associated with the vehicle operation or vehicle state, such as engine parameters, electronics parameters, navigation parameters, communications parameters, or other vehicle operation parameters. The vehicle-state module 854 may be accessed by the vehicle-state analysis module 846. The general purpose memory 842 and the modules 844-854 may be in the form of volatile memory, such as DRAM, SRAM, or EPROM, or may be non-volatile memory such as flash, floppy disk, hard disk, removable media such as DVD or CD, or other storage media.

The input/output module 855 may include a microphone system 856, speakers 858, such as loudspeakers or headphones, and operator inputs 860. The microphone system 856 may include noise-canceling microphones, directional microphones, or microphones interfaced to other devices which in communication with the communications interface 804 through the bus 802. Operator inputs 860 may be received from joysticks, touch pads, speech recognition units, haptic inputs, light pens, touch screen styli, touch screens, capacitance detection pads, tablet screens, track balls, track pointers, mouse inputs, wired or wireless remote units, and other input devices that allow a user to input information.

The bus interface 832 may include circuitry, software, firmware, source code, or object code configured to allow the communications interface 804 to interact with the modules interfaced to the vehicle system bus 800 through the bus 802. The bus interface 832 may process bus instructions transmitted through the bus interface 832 and may prioritize, route, delete, modify, or queue signals or instructions transmitted through the bus 832. Examples of system bus architecture include Local Interconnect Network (LIN), Controller Area Network (CAN), J1939, IS011783, FlexRay, Media Oriented Systems Transport (MOST), Keyword Protocol 2000 (KWP2000), Vehicle Area Network (VAN), DC-BUS, IDB-1394. and SMARTwireX.

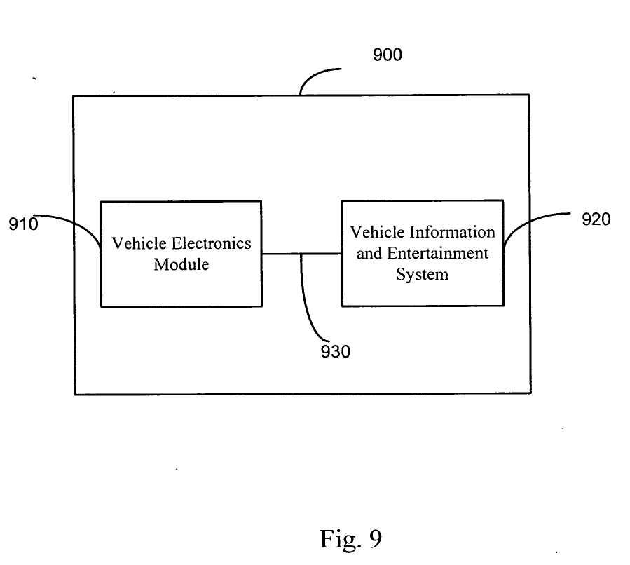

FIG. 9 illustrates a vehicle configuration. A vehicle 900 may include a vehicle electronics module 910 and a vehicle information and entertainment system 920. The vehicle electronics module 910 and the vehicle information and entertainment system 920 may be coupled to a vehicle system bus 930. The vehicle information and entertainment system 920 may include a CPU 111, a GPS receiver 102, a display 726, and logic to control navigation and display of determined routes, such as described in FIGS. 1 and 2. The vehicle system bus 930 may include communications interfaces and bus interface modules. The vehicle electronics module 910 may include modules for vehicle operation, navigation, audio and video inputs and outputs, signal inputs and outputs, and other modules related to a vehicle operation or control. A vehicle may include an automobile, a truck, a motorcycle, an all-terrain vehicle, or other land conveyance, an airplane, a helicopter, a balloon, or other aerial vehicles, a boat, a submarine, or other water-borne craft, rockets, and space-borne vehicles.

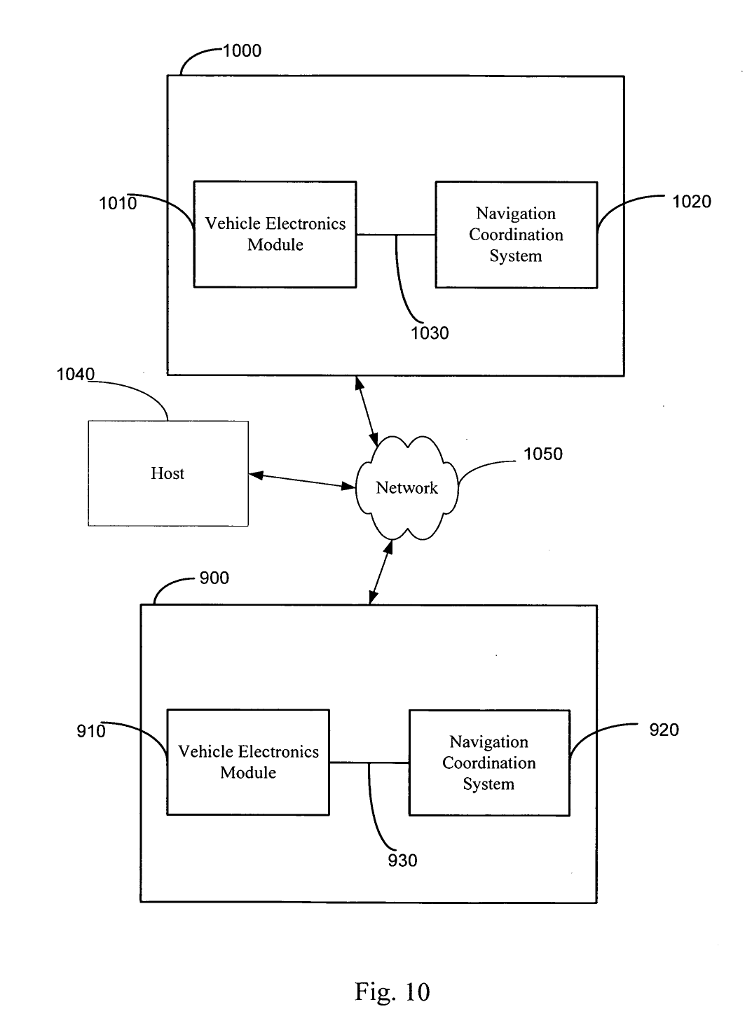

FIG. 10 illustrates an alternate first vehicle information and entertainment system 900 and a second vehicle information and entertainment system 1000. The first vehicle information and entertainment system 900 and the second vehicle information and entertainment system 1000 may communicate with a host 1040. The host 1040 may be in communication with the first vehicle information and entertainment system 900 and the second vehicle information and entertainment system 1000 through a network 1050. The network 1050 may include a wireless network such as a wireless telephone network, a wireless TCP/IP network, a radio network, a satellite communications network, or other wireless protocol network. The wireless telephone network may comprise an AMPS network, a CDMA network, a GSM network, or other cellular telephone network. The wireless TCP/IP network may comprise a WiFi network, a WiMax network, a GPRS network, a CDPD network, or other packet switched network. The second vehicle information and entertainment system 1000 may include a navigation system 100 as illustrated in FIG. 1. The first vehicle information and entertainment system 900 and the second vehicle information and entertainment system 1000 may communicate with each other as described in FIGS. 3-5. The first vehicle information and entertainment system 900 and the second vehicle information and entertainment system 1000 may coordinate a rendezvous position as described in FIG. 5. Each vehicle information and entertainment system 900 and 1000 may accept and process input from modules interfaced to the vehicle information and entertainment system 900 and 1000 and transmit this input through the network 1050. In some systems, a user may transmit a desired point of interest or desired rendezvous points to vehicle information and entertainment system not in the user's vehicle by using the resident vehicle information and entertainment system. The first vehicle information and entertainment system 900 and the second vehicle information and entertainment system 1000 may be configured in a same or a different way.

The navigation system may provide for route coordination of navigation devices. The navigation system may provide a rendezvous function for two or more navigation devices, by exchanging positional data between navigation devices in a highly automated manner.

Like the method shown in FIGS. 3-5, the sequence diagrams may be encoded in a signal bearing medium, a computer readable medium such as a memory, programmed within a device such as one or more integrated circuits, or processed by a controller or a computer. If the methods are performed by software, the software may reside in a memory resident to or interfaced to the CPU 111 and 235, a communication interface, or any other type of non-volatile or volatile memory interfaced or resident to the first or second navigation device 101 and 205. The memory may include an ordered listing of executable instructions for implementing logical functions. A logical function may be implemented through digital circuitry, through source code, through analog circuitry, or through an analog source such as through an analog electrical, audio, or video signal. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine-readable medium,” “propagated-signal” medium, and/or “signal-bearing medium” may comprise any means that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A method that coordinates navigation devices comprising:
receiving data at a first navigation device in a first vehicle,
receiving navigation data in a second vehicle, where the navigation data comprises data related to a position of a second navigation device, and
calculating positional data in the first navigation device based on the received data.

2. The method of claim 1 further comprising transmitting a third set of data from the first navigation device to the second navigation device, the third set of data comprising at least a portion of the calculated positional data.

3. The method of claim 1 further comprising transmitting a request from the first navigation device to the second navigation device to initiate a transmission of the navigation data.

4. The method of claim 3 further comprising transmitting a confirmation signal by the second navigation device to acknowledge a data communication with the first navigation device.

5. The method of claim 1 where the positional data comprise a common point of a proposed route for the first navigation device and the second navigation device.

6. The method of claim 2 further comprising calculating positional data in the second navigation device based on a position of the second navigation device and the third set of data.

7. The method of claim 6 where the positional data in the first navigation device and the positional data in the second navigation device are calculated based on an estimated average speed of the first navigation device and the second navigation device.

8. The method of claim 1 further comprising receiving updated navigation data and calculating the positional data in the first navigation device based on the updated navigation data.

9. A method that coordinates routes of a plurality of navigation devices comprising:
transmitting position data of each of the plurality of navigation devices through a network to a host, where the position data includes at least a destination of each route and a position of each navigation device;
determining an intermediate position for each route of the plurality of navigation devices by the host; and
transmitting the intermediate position for each route to the navigation device associated with each route.

10. The method of claim 9 where the host is located at a service provider.

11. The method of claim 9 where the host device is operable as a navigation device based on a global positioning system.

12. The method of claim 9 further comprising determining the route in each navigation device based on the intermediate position of the route and the position of the navigation device.

13. A navigation device comprising:
a position receiver configured to receive and to decode a first signal indicating a position of the navigation device;
a first request signal configured for communication with an external device and external positional data through a communications network;
a confirmation receiver configured to receive and to decode a confirmation signal for communication with the external device, and a second request signal from the external device;
a calculating unit configured to calculate, upon receipt of the confirmation signal by the confirmation receiver, positional data for a route of the navigation device based on the request signal and the external position data; and
a transmitter configured to encode the confirmation signal, the request signal and the positional data, and to send a signal comprising at least one of the request signal and the positional data.

14. The navigation device of claim 13 where the confirmation receiver and the transmitter each comprise an interface for wireless communication with the external device.

15. The navigation device of claim 14 where the confirmation receiver and the transmitter each comprise an interface to a mobile phone.

16. The navigation device of claim 13 where the confirmation receiver and the transmitter each comprise a high frequency demodulator and a high frequency modulator, respectively, so as to receive the confirmation signal and transmit the first request signal, respectively.

17. The navigation device of claim 13 where the calculation unit is configured to calculate the positional data based on geographical data.

18. The navigation device of claim 13 further comprising a user interface configured to report the first request signal to a user, and to initiate the transmission of the confirmation signal upon user request.

19. A navigation system comprising a first navigation device and a second navigation device according to claim 18, the system further comprising a host configured to receive positional data from the first navigation device and the second navigation devices, calculate first proposed positional data and second proposed positional data for the first navigation device and the second navigation devices, and to communicate the first proposed positional data to the first navigation device and the second proposed positional data to the second navigation device to coordinate a route.

20. The navigation system of claim 19 where the host unit is implemented in at least one of the first navigation device and the second navigation device, and where at least one of the first navigation device and the second navigation device comprising the host activates the host upon user request.

21. The navigation system of claim 19 where the host is coupled to a network service provider.
